(19) United States
(12) Patent Application Publication
(10) Pub. No.: US 2006/0175858 A1
(43) Pub. Date: Aug. 10, 2006

(54) Piece of equipment comprising a rigid support frame and a flexible lining and vehicle comprising one such piece of equipment

(76) Inventors: Nicolas Pegorier, Isle Adam (FR); Freddy Stoof, Nanterre (FR)

Correspondence Address: YOUNG & THOMPSON, 745 SOUTH 23RD STREET, 2ND FLOOR, ARLINGTON, VA, 22202, US

(21) Appl. No.: 10/543,128

(22) PCT Filed: Jan. 22, 2004
(86) PCT No.: PCT/FR04/00146

§ 371 Date: Dec. 27, 2005

(30) Foreign Application Priority Data
Jan. 22, 2003 (FR) 03/00685

(51) Int. Cl. B62D 25/14

(52) U.S. Cl. 296/70

(57) ABSTRACT

A piece of equipment includes a rigid support frame (5) and a flexible lining (7) which covers the outer face (9) of the support frame, the lining includes an outer covering (17). The lining hass protrusions (19, 27) which project out from the outer covering (17) and which rest on the outer face (9) of the support frame (5). According to the invention, spaces (21) for the deformation of the lining are defined between the protrusions, thereby making the lining flexible. The invention can be used, for example, to produce instrument panels.

The present invention relates to an item of equipment for a motor vehicle of the type comprising a rigid supporting reinforcement and a flexible padding covering the outer face of the supporting reinforcement, the padding having an outer covering skin.

The invention applies in particular to dashboards.

Document FR-2 729 913 describes a dashboard of the aforementioned type.

The flexible padding comprises a layer of foam interposed between the outer covering skin and the rigid supporting reinforcement. This foam layer gives the padding its flexibility and thickness which contributes to comfort inside the motor vehicle.

However, the overall cost of producing the dashboard is relatively high, in particular because the foam layer can prove to be complex.

One object of the invention is to solve this problem by providing an item of equipment of the aforementioned type, which provides satisfactory comfort while being less expensive to produce.

Accordingly, the invention relates to an item of equipment, wherein the padding has projections that are made in one piece with the outer skin and that rest on the outer face of the supporting reinforcement, and wherein the projections delimit between them deforming spaces of the padding to give it its flexibility.

According to particular embodiments, the item of equipment may comprise one or more of the following characteristics, taken in isolation or according to all technically possible combinations

the item of equipment comprises means for attaching the padding onto the supporting reinforcement;

the means of attachment comprise snap-on devices;

a housing for receiving a movable element is provided in the supporting reinforcement;

a movable device controlling an accessory of the motor vehicle is accommodated in the housing;

at least one projection of the padding rests on the control device and said projection is separated from the projections of the padding that rest on the supporting reinforcement around the housing;

the projections are ribs and the deforming spaces are cells delimited between the ribs;

the item includes means for putting the spaces into communication with each other and/or with the outside atmosphere; and

the item constitutes a dashboard of a motor vehicle.

The invention also concerns a motor vehicle having an item of equipment, wherein the item of equipment is an item such as defined above.

The invention will be better understood on reading the following description, given solely as an example, and made with reference to the accompanying drawings, in which:

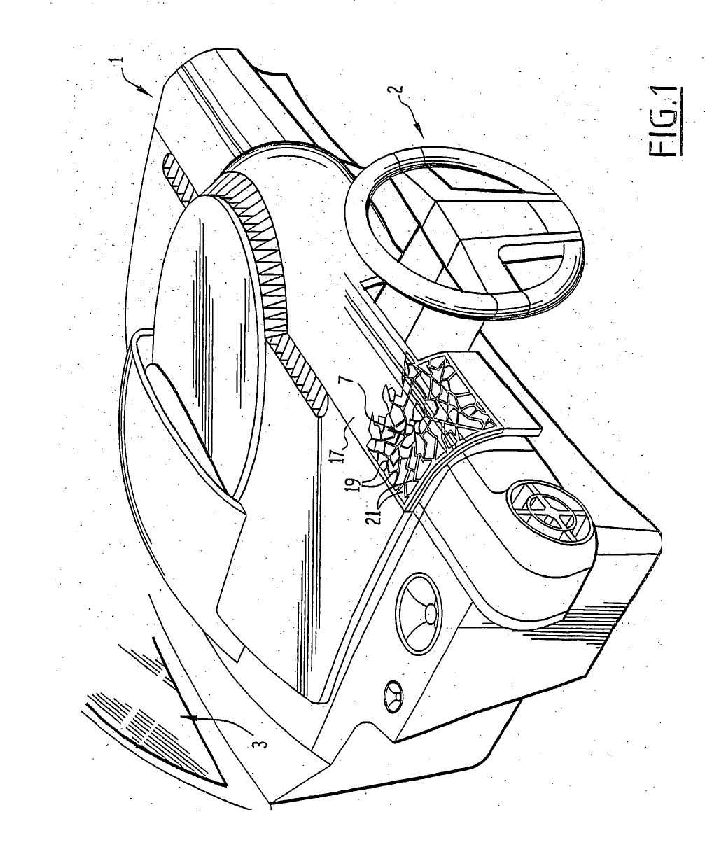

FIG. 1 is a partial perspective diagrammatic view of the interior of a motor vehicle according to the invention,

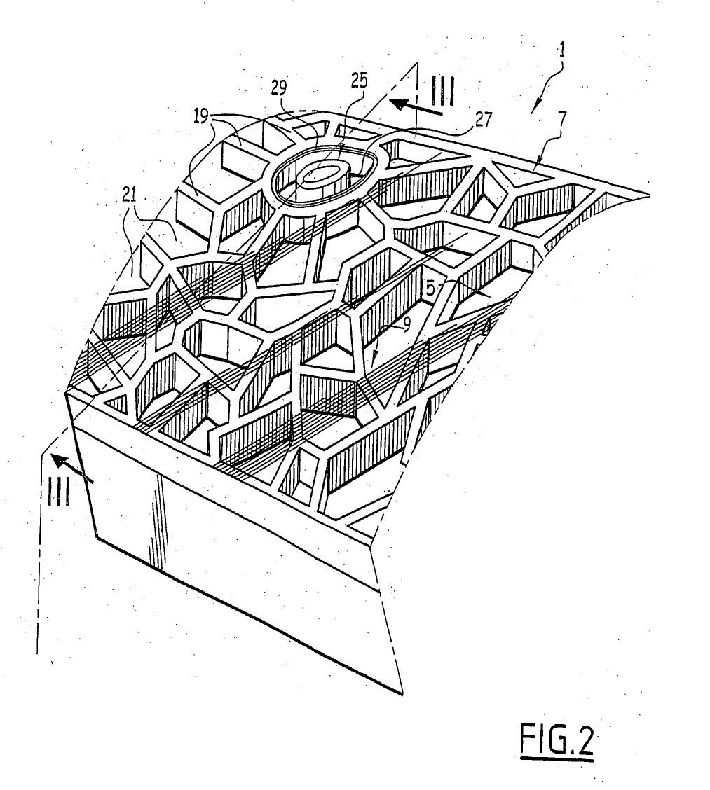

FIG. 2 is an enlarged partial perspective diagrammatic view of a length of the dashboard of the vehicle of FIG. 1,

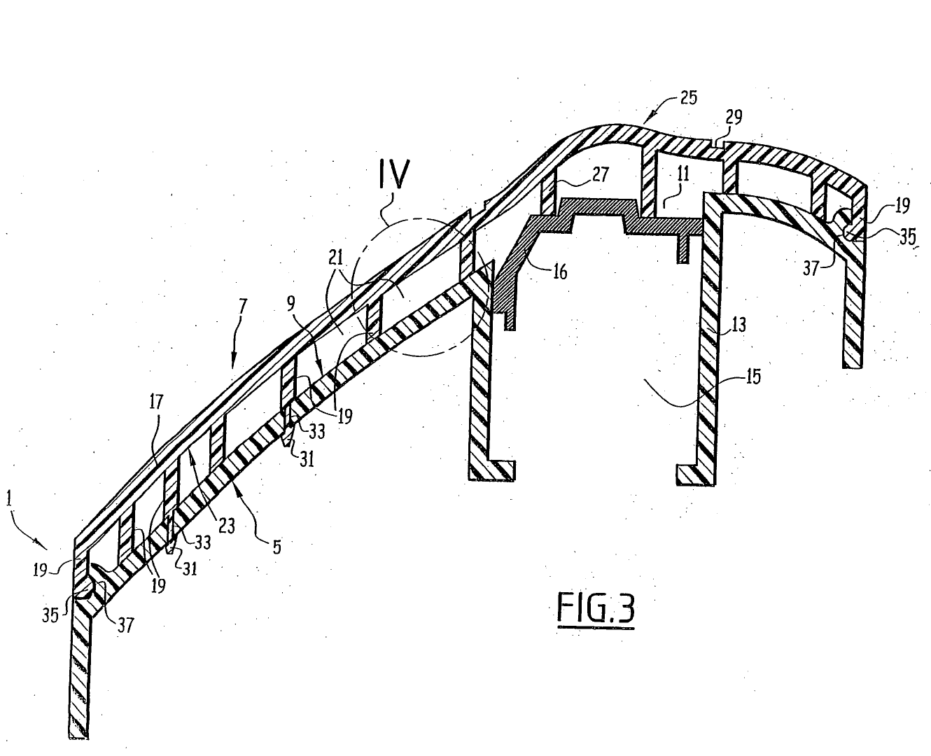

FIG. 3 is an enlarged sectional diagrammatic view taken along the plane III-III of FIG. 2,

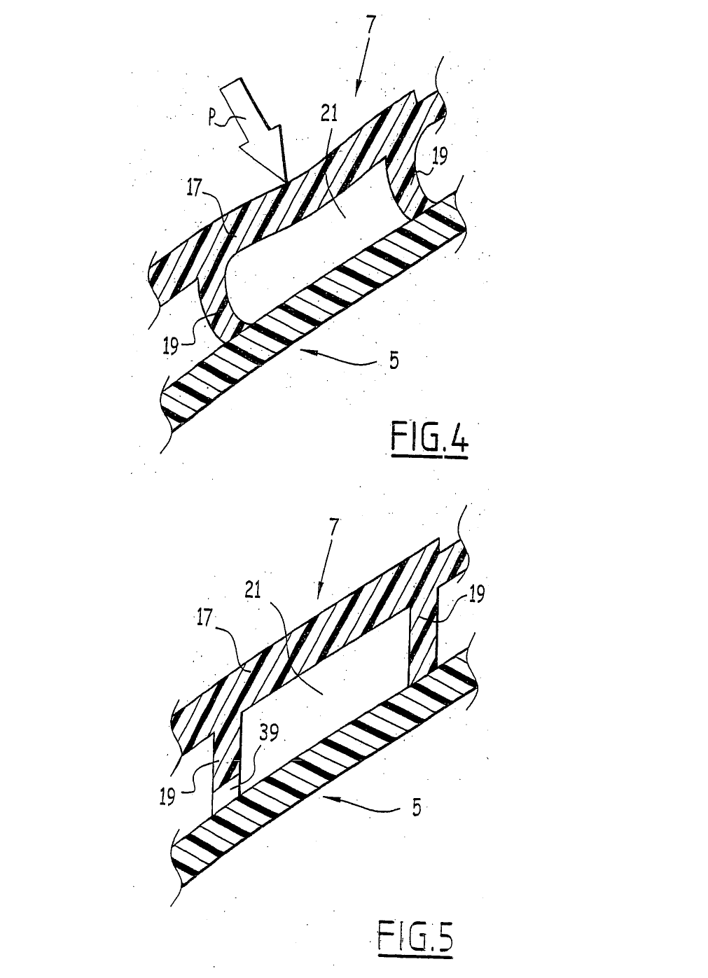

FIG. 4 is an enlarged diagrammatic view of the circled part IV of FIG. 3 illustrating a deformation of the padding of the dashboard, and

FIG. 5 is a similar view to that of FIG. 4 illustrating a variant of the dashboard in the absence of deformation.

FIG. 1 illustrates the interior of a motor vehicle. A dashboard will in particular be noticed there, as well as a steering wheel 2 and a windscreen 3.

The terms “front”, “rear”, “right”, “left”, “lower” and “upper” will hereinafter be understood to be in relation to the position of a driver and in the direction of motion of the motor vehicle. The terms “inner” and “outer” are understood to be in relation to the dashboard 1.

As illustrated more particularly in FIGS. 2 and 3, the dashboard 1 comprises a rigid supporting reinforcement 5 and a flexible padding 7 covering the outer face 9 of the supporting reinforcement 5.

The supporting reinforcement 5, sometimes called an insert, is attached conventionally to the body of the motor vehicle. It is made for example of a polyolefinic thermoplastic that is a homopolymer or a copolymer, possibly including inorganic fillers or a glass fibre reinforcement, or for example is made of ABS-PC (acrylonitrile-butadiene-styrene and polycarbonate) possibly reinforced by glass fibres. These materials have a rigidity that will enable a supporting function to be fulfilled.

The supporting reinforcement 5 is curved so as to give the dashboard 1 its shape.

A substantially circular orifice 11 (FIG. 3) is provided in the reinforcement 5. The reinforcement 5 is extended inwards, in line with the orifice 11, by a sleeve 13 that delimits, with the orifice 11, a passage 15.

A pushbutton 16 is received in the passage 15 so that it can slide between a first position shown in FIG. 3 where it is substantially flush with the outer surface 9 of the reinforcement 5 and a second depressed position (not shown) for actuating one or more accessories of the motor vehicle, for example hazard lights.

The flexible padding 7 has an outer covering skin 17 extended towards the inside of the dashboard 1 by a network of ribs 19 delimiting cells 21 between them.

The padding 7, and therefore the skin 17 and the ribs 19, are made in one piece of plastics material, for example made of elastomeric thermoplastic such as thermoplastic polyurethane (TPU) or thermoplastic polyolefin (TPO). It is also possible to use flexible polyvinyl chloride (PVC) or a rubber such as silicone rubber. The padding 7 is therefore appreciably more flexible than the reinforcement 5.

The material used to form the padding 7 of FIGS. 1 to 3 is translucent as has been shown in FIG. 2 and on the left hand region of the dashboard 1 of FIG. 1

Thus an observer can distinguish the ribs 19 from the outside of the dashboard 1 through the skin 17. In order to facilitate the illustration, the padding 7 has on the other hand been shown as opaque in FIG. 3.

The ribs 19 extend from the inner face 23 of the skin 17 as far as the outer face 9 of the reinforcement 5 on which they rest. It will be noted that most of the ribs 19 are not at right angles to the directrix surfaces of the reinforcement 5 and the skin 17.

The region 25 of the skin 17 positioned facing the button 16 is extended inwards by a substantially annular rib 27.

The rib 27 rests on the outer face of the button 16.

A substantially annular outer groove 29 delimits the region 25 with respect to the rest of the skin 17 and the rib 27 is isolated from the rest of the network of ribs 19. Thus, the region 25 can deform under the action of a finger of an occupant of the motor vehicle to enable the button 16 to be moved from its first position to its second position.

Some of the ribs 19 remote from the edges of the skin 17 are provided with snap-on hooks 31 which pass through the openings 33 provided in the reinforcement 5 (FIG. 3).

The ribs 19 situated at the edges of the skin 17 are provided with projecting snap-on edges 35 accommodated in complementary grooves 37 provided in the edges of the reinforcement 5.

Thus, by means of the hooks 31 and the edges 35, the padding 7 is held in relation to the reinforcement 5, and the ribs 19 are held resting against the reinforcement 5. The trim 7 is thus attached to the reinforcement 5.

Since the padding 7 is made of a flexible material and cells 21 are delimited between the ribs 19, the padding 17 can deform on touch.

As illustrated in FIG. 4, this deformation can result from a buckling of the ribs 19 situated in the vicinity of the point of application of a thrust force P and flexing of the region or regions of the skin 17 situated between these ribs. More generally, this deformation can also result from a pivoting, with respect to the skin 17, of the ribs 19 that are not at right angles to the directrix surfaces of the reinforcement 5 and of the skin 17, or one or more of the three aforementioned phenomena.

The ribs 19 and the deforming cells 21 therefore provide the trim 7 with its flexibility and thickness so that satisfactory comfort is obtained.

Moreover, this comfort does not require the use of a foam layer. The cost of the dashboard 1 is therefore reduced since it is easier to produce the padding 7 and requires less material than if a foam layer were present.

This cost is even lower on account of the fact of the use of a snap-on attachment. However, other means can be used that are different from the snap-on means of attachment.

Accordingly, the trim 7 can be glued or welded onto the supporting reinforcement 5.

In such a variant illustrated in FIG. 5, and order to avoid the problems of thermal expansion of the air present inside the cells 21 which could bring about unsightly deformations, the ribs 19 and 27 have cut-outs 39 enabling the cells 21 to be put into communication with each other.

The ribs 19 situated on the edge of the skin 17 also have cut-outs 39 for putting the network of cells 21 made up in this way in communication with the atmosphere of the vehicle's interior. Thus, the pressure difference between the air contained in any one of the cells 21 and the atmosphere of the vehicle's interior is substantially zero.

More generally, the structure of the dashboard 1 without foam makes it possible for control devices such as the pushbutton 16 to be easily incorporated.

The dashboard 1 also proves to be more easily recyclable on account of the fact that detaching the padding 7 from the supporting reinforcement 5 can be much more easily and completely achieved than in the case of a foam padding.

It will be noted that the ribs 19 and 27 may be replaced by pins delimiting between them deforming spaces of the padding 7.

It will also be noted that the use of a translucent or transparent material to form the padding 7 makes it possible to give the dashboard an original attractive appearance, for example a crocodile skin or mosaic appearance, at reduced cost. However, in other variants, the material used is opaque.

It will be easily understood that it will be possible, according to requirements, to adapt the flexibility of the padding 7 according to the present invention by varying the combination of parameters of said padding 7 consisting principally of the height and thickness of the ribs 19, the mechanical properties of the material making up the padding 7 and the average size of the cells 21.

More generally, the principles described above can be applied to the production of items of equipment other than dashboards, for example door panels.

1. An item of equipment (1) for a motor vehicle, of the type comprising a rigid supporting reinforcement (5) and a flexible padding (7) covering the outer face (9) of the supporting reinforcement, the padding having an outer covering skin (17), wherein the padding has projections (19, 27) that are made in one piece with the outer skin (17) and that rest on the outer face (9) of the supporting reinforcement (5), and wherein the projections (19, 27) delimit between them deforming spaces (21) of the padding to give it its flexibility.

2. The item of equipment as claimed in claim 1, wherein it includes means (31, 33, 35, 37) for attaching the padding (7) onto the supporting reinforcement (5).

3. The item of equipment as claimed in claim 2, wherein the means of attachment comprise snap-on devices (31, 33, 35, 37).

4. The item of equipment as claimed in claim 1, wherein a housing (15) for accommodating a movable device (17) is provided in the supporting reinforcement (5).

5. The item of equipment as claimed in claim 4, wherein a movable device (17) for controlling an accessory of the motor vehicle is accommodated in the housing (15).

6. The item of equipment as claimed in claim 5, wherein at least one projection (27) of the padding (7) rests on the control device (17), and wherein said projection (27) is separated from the projections (19) of the padding (7) that rest on the supporting reinforcement (5) around the housing (15).

7. The item of equipment as claimed in claim 1, wherein the projections are ribs (19, 27) and wherein the deforming spaces are cells (21) delimited between the ribs (19, 27).

8. The item of equipment as claimed in claim 1, wherein it includes means (39) for putting the spaces (21) into communication with each other and/or with the outside atmosphere.

9. The item of equipment as claimed in claim 1, wherein it constitutes a dashboard of a motor vehicle.

10. A motor vehicle having an item of equipment (1), wherein the item of equipment is an item according to claim 1.
